(19) United States
(12) Patent Application Publication
(10) Pub. No.: US 2008/0182476 A1
(43) Pub. Date: Jul. 31, 2008

(54) VACUUM/EXHAUST AND GETTER TUBE

(75) Inventors: Byung-Soo Kim, Seoul (KR); Yong-Sang Cho, Seoul (KR); Hyo-Young Lee, Gyeonggi-do (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Micron Ltd.

(21) Appl. No.: 11/669,104

(22) Filed: Jan. 30, 2007

(51) Int. Cl. H01J 9/38

(52) U.S. Cl. 445/73

(57) ABSTRACT

Disclosed herein is a vacuum/exhaust and getter tube that is capable of mitigating the difficulty of performing a tip-off process, which is caused by respectively separating an exhaust tube and a getter tube from holes. The vacuum/exhaust and getter tube includes a tube upper and lower ends of which are open, and a getter which is inserted into the tube.

The present disclosure relates to subject matter contained in priority Korean Application No. 10-2005-0070072, filed on Jul. 30, 2005, which are herein expressly incorporated by reference in their entirety.

### BACKGROUND OF THE INVENTION

1. Field of the Invention

The present invention relates to a vacuum/exhaust and getter tube that is capable of mitigating the difficulty of performing a tip-off process, which is caused by respectively separating an exhaust tube and a getter tube from holes.

2. Description of the Related Art

Cold-Cathode Fluorescent Lamps (CCFLs) are mainly used as lamps for various illumination devices or displays. Such CCFLs are classified according to the location of electrodes, as either Internal Electrode Fluorescent Lamps (IEFLs), in which electrodes are installed inside sealed glass tubes containing discharge gas and gaseous mercury and fluorescent material is applied to the inside surfaces of the glass tubes, or External Electrode Fluorescent Lamp (EEFLs), in which electrodes are installed outside glass tubes and fluorescent material is formed on the inside surfaces of the glass tubes.

When high-frequency Alternating Current (AC) signals are applied to the internal electrodes of an IEFL, an electric field is generated between the electrodes, therefore plasma discharge is generated. Electrons, which are generated during the discharge, excite mercury, and ultraviolet rays are generated. Thereafter, the ultraviolet rays excite fluorescent material and cause the transition of the fluorescent material, thus resulting in the generation of visible rays.

In contrast, when high-frequency AC signals are applied to the external electrodes of an EEFL, plasma discharge is generated between positive electrodes inside a glass tube, electrons are generated, and mercury is excited by the electrons and causes fluorescent material to emit light. Such an EEFL has advantages in that the amount of heat is low and the EEFL is driven at high efficiency because wall charges are formed on the inner surface of a glass tube near electrodes by plasma discharge and plasma discharge is in turn generated using the wall charges, and a plurality of EEFLs can be driven using a single inverter because voltage drop is very small.

Meanwhile, an LCD displays images by adjusting the transmissivity of liquid crystal cells in response to video signals. An active matrix LCD has an advantage in its ability to display moving images because switching elements are formed for respective liquid crystal cells. Thin Film Transistors (hereinafter referred to as “TFTs”) are chiefly used as the switching elements.

An LDC is not a self-emissive device, therefore it requires a separate backlight unit. Conventional backlight units for LCDs are classified into edge light-type backlight units, each of which converts light, radiated from a lamp located at one end thereof, into surface light using a light guide plate, and radiates the surface light onto an LCD panel, and direct light-type backlight units, each of which radiates light onto an LCD panel using a plurality of lamps located under the LCD panel.

Recently, research and development into Light source devices, which have light emission efficiency, luminance, and uniformity of luminance greater than those of existing edge light type backlight units or existing direct light type backlight units, is being actively conducted.

Such an LIGHT SOURCE DEVICE, as shown in FIG. 1, includes a front glass substrate 11 provided with an exhaust hole 11a and a mercury injection hole 11b, a rear glass substrate 12 sealed to the front glass substrate 11 with partitions 14 and plasma discharge channels 19 interposed therebetween, a plurality of electrodes 13 formed on the rear glass substrate 12, and fluorescent material 15 applied on the surfaces of the partitions 14 and the glass substrates 11 and 12 within the plasma discharge channels 19.

A vacuum/exhaust process for such an LIGHT SOURCE DEVICE is performed by attaching a vacuum/exhaust tube 16 to an exhaust hole 11a using a sealant and then exhausting air from the plasma discharge channels 28 to the outside through the vacuum/exhaust tube 16 using a vacuum pump (not shown). A discharge gas injection process is performed by injecting discharge gas, including inert gas, into the plasma discharge channels 19 through the vacuum/exhaust tube 16.

A mercury injection process for the LIGHT SOURCE DEVICE is performed by attaching a getter tube 17, into which a getter 18 has been inserted, to the mercury injection hole 11b using a sealant, and activating the getter 18 in such a way as to place an inductor (not shown) near the getter tube 17 and apply induced current to the getter 18 in the getter tube 17 through the application of Alternating Current (AC) to the inductor, with the result that mercury is injected into the plasma discharge channels 19.

After the above-described vacuum/exhaust process, discharge gas injection process and mercury injection process have been completed, a tip-off process of separating the vacuum/exhaust tube 16 from the exhaust hole 11a and the getter tube 17 from the mercury injection hole 11b is performed, and, finally, a process of sealing the exhaust hole 11a and the mercury injection hole 11b is performed.

Meanwhile, a conventional LIGHT SOURCE DEVICE manufacturing process has disadvantages in that the exhaust tube 16 and the getter tube 17 are respectively separated from the holes in the tip-off process, and in that the exhaust hole 11a and the mercury injection hole 11b must be sealed after the tip-off process. Furthermore, the conventional LIGHT SOURCE DEVICE has a problem in that the luminance around the exhaust hole 11a and the mercury injection hole 11b is lower than that in other effective light emission regions, therefore the uniformity of luminance is relatively low.

### SUMMARY OF THE INVENTION

Accordingly, the present invention has been made keeping in mind the above problems occurring in the prior art, and an object of the present invention is to provide a vacuum/exhaust and getter tube that is capable of simplifying a tip-off process for an LIGHT SOURCE DEVICE and improving the uniformity of luminance.

In order to accomplish the above object, the present invention provides a vacuum/exhaust and getter tube, including a tube the upper and lower ends of which are open; and a getter which is inserted into the tube.

The tube includes a first tube the upper and lower ends of which are open; a second tube into which the getter is inserted, and the upper and lower ends of which are open; and a first neck portion which is formed between the first and second tubes to be narrower than each of the first and second tubes, and which provides a passage between the first and second tubes.

The vacuum/exhaust and getter tube further includes a second neck portion which is formed at the lower end of the second tube to be narrower than the second tube, and which provides a passage between the second tube and the plasma discharge channels of an LIGHT SOURCE DEVICE.

Each of the first and second neck portions has an inner diameter smaller than the diameter of the getter.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a conventional LIGHT SOURCE DEVICE, a conventional vacuum/exhaust tube and a conventional getter tube;

FIG. 2 is a sectional view showing an LIGHT SOURCE DEVICE and a vacuum/exhaust and getter tube according to an embodiment of the present invention;

FIG. 3 is a partial cutaway perspective view showing the structure of the vacuum/exhaust and getter tube of FIG. 2 in detail;

FIG. 4 is a sectional view showing an LIGHT SOURCE DEVICE and a vacuum/exhaust and getter tube according to another embodiment of the present invention; and

FIG. 5 is a partial cutaway perspective view showing the structure of the vacuum/exhaust and getter tube of FIG. 4 in detail.

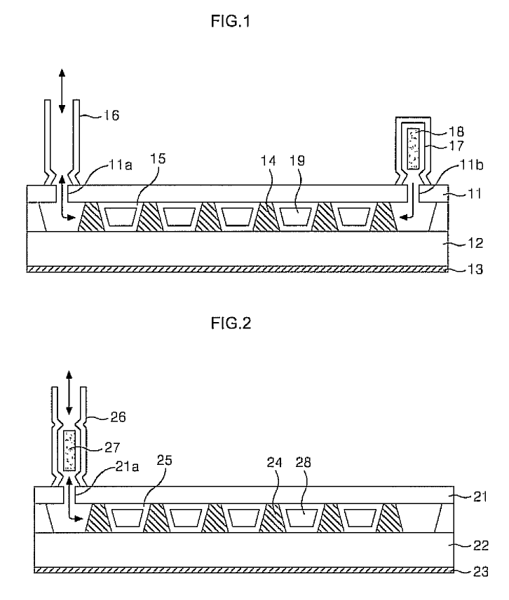

### DESCRIPTION OF THE PREFERRED EMBODIMENTS

Reference now should be made to the drawings, in which the same reference numerals are used throughout the different drawings to designate the same or similar components.

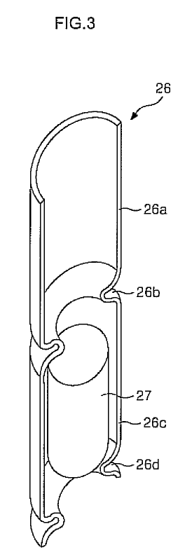

With reference to FIGS. 2 to 5, preferred embodiments of the present invention are described below.

Referring to FIGS. 2 and 3, an LIGHT SOURCE DEVICE according to an embodiment of the present invention includes a front glass substrate 21 provided with an exhaust/mercury injection hole 21a, a rear glass substrate 22 sealed to the front glass substrate 21 with partitions 24 and plasma discharge channels 28 disposed therebetween, a plurality of electrodes 23 formed on the rear glass substrate 22, and fluorescent material 25 applied to the surfaces of the partitions 24 and the glass substrates 21 and 22 within the plasma discharge channels 28.

Holes (not shown) are formed through the partitions 24 to form a passage so that gas can move between the plasma discharge channels 28.

A vacuum/exhaust process for the LIGHT SOURCE DEVICE is performed by attaching a vacuum/exhaust and getter tube 26, into which a getter 27 has been inserted, to the exhaust/mercury injection hole 21a using a sealant and then exhausting air from the plasma discharge channels 28 to the outside through the vacuum/exhaust and getter tube 26 using a vacuum pump. A discharge gas injection process is performed by injecting discharge gas, including inert gas, into the plasma discharge channels 28 through the vacuum/exhaust and getter tube 26. Thereafter, mercury is injected to the plasma discharge channels 28 by activating the getter 27 in such a way as to place an inductor (not shown) near the vacuum/exhaust and getter tube 26 and apply induced current to the getter 27 in the vacuum/exhaust and getter tube 26 through the application of AC current to the inductor.

After the vacuum/exhaust process, the discharge gas injection process and the mercury injection process have been completed using the vacuum/exhaust and getter tube 26, as described above, a tip-off process of separating the vacuum/exhaust and getter tube 26 from the exhaust/mercury injection hole 21a is performed, and finally, a process of sealing the exhaust/mercury injection hole 21a is performed.

As a result, in the process of manufacturing an LIGHT SOURCE DEVICE according to the present invention, only the single vacuum/exhaust and getter tube 26 is separated from the hole 21a in the tip-off process, therefore the tip-off process is simplified, and only the single hole 21a is formed through the substrate 11, therefore luminance and the uniformity of luminance can be improved.

The LIGHT SOURCE DEVICE according to the present invention can be used as a light source for a non-emissive device, such as a general illumination device or an LCD.

FIG. 3 is a perspective view of the vacuum/exhaust and getter tube 26.

Referring to FIGS. 2 and 3, the vacuum/exhaust and getter tube 26 includes first and second glass tubes 26a and 26c connected to each other with a first neck portion 26b disposed therebetween, and a getter 27 inserted into the second glass tube 26c.

The first glass tube 26a is a cylindrical glass tube, the upper and lower ends of which are open, and functions to form a passage between the outside and the plasma discharge channels 28 in the vacuum/exhaust process and the discharge gas injection process. The lower end of the first glass tube 26a is formed to have an inner diameter smaller than the diameter of the getter 27.

The second glass tube 26c is a cylindrical glass tube which has an inner diameter greater than the diameter of the getter 27 and the upper and lower ends of which are open, and functions to form a passage between the outside and the plasma discharge channels 28 in the vacuum/exhaust process and the discharge gas injection process, and to form a passage through which mercury is injected from the getter 27 into the plasma discharge channels 28 at the time of activation of the getter 27. Each of the upper and lower ends of the second glass tube 26c is formed to have an inner diameter smaller than the diameter of the getter 27.

The first neck portion 26b functions to connect the first and second glass tubes 26a and 26c to each other, to form a passage therebetween, and to confine the getter 27 within the second glass tube 26c. The first neck portion 26b includes the lower end of the first glass tube 26a and the upper end of the second glass tube 26c, each of which has an inner diameter smaller than the diameter of the getter 27.

The second neck portion 26d corresponds to the lower end of the second glass tube 26c, which has an inner diameter smaller than the diameter of the getter 27, and functions to form a passage between the second glass tube 26c and the plasma discharge channels 28 via the exhaust/mercury injection hole 21a, and to confine the getter 27 within the second glass tube 26c. This second neck portion 26d is attached to the portion of the front glass substrate 21 near the exhaust/mercury injection hole 21a using a sealant.

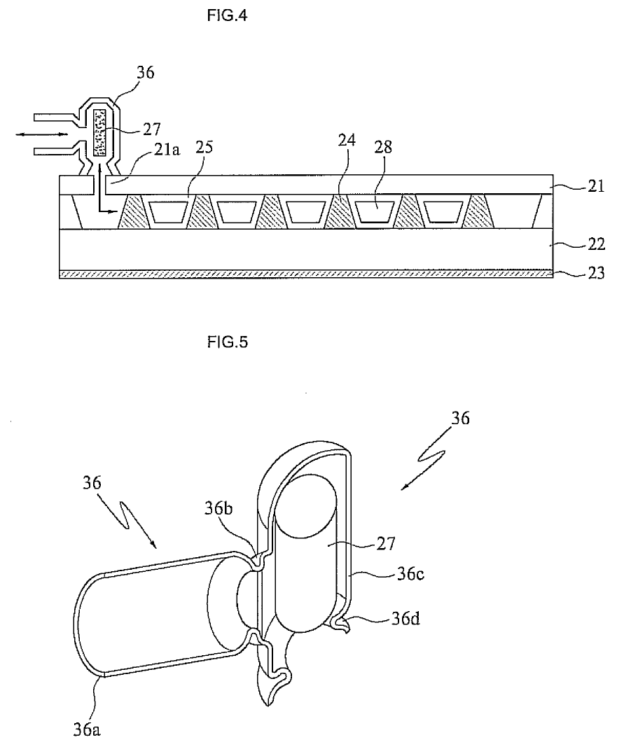

In FIGS. 4 and 5 is shown a vacuum/exhaust and getter tube 36 according to another embodiment of the present invention.

Referring to FIGS. 4 and S, the vacuum/exhaust and getter tube 36 according to another embodiment of the present invention is different from the vacuum/exhaust and getter tube 26 shown in FIGS. 2 and 3 in that the lower end and a side portion thereof, rather than the upper and lower ends thereof, are open.

The side opening of the vacuum/exhaust and getter tube 36 is sealed after the air within the plasma discharge channels 28 has been exhausted to the outside, and the lower opening of the vacuum/exhaust and getter tube 36 is attached to a front glass substrate 21, in which an exhaust/mercury injection hole 21a is formed, and functions as a passage through which air is exhausted to the outside and mercury is injected into plasma discharge channels 28.

The vacuum/exhaust and getter tube 36 includes first and second glass tubes 36a and 36c connected to each other with a first neck portion 36b disposed therebetween, and a getter 27 inserted into the second glass tube 36c. Here, the first and second glass tubes 36a and 36c are connected perpendicular to each other, so that a first neck portion 36b is formed on the side of the vacuum/exhaust and getter tube 36.

The first glass tube 36a is a cylindrical glass tube the front and rear ends of which are open, and functions to form a passage between the outside and the plasma discharge channels 28 in the vacuum/exhaust process and the discharge gas injection process. The rear end of the first glass tube 36a is formed to have an inner diameter smaller than the diameter of the getter 27.

The second glass tube 36c is a cylindrical glass tube which has an inner diameter greater than the diameter of the getter 27 and the side and lower end of which are open, and functions to form a passage between the outside and the plasma discharge channels 28 in the vacuum/exhaust process and the discharge gas injection process, and to form a passage through which mercury is injected from the getter 27 into the plasma discharge channels 28 at the time of activation of the getter 27. Each of the side and lower end of the second glass tube 26c is formed to have an inner diameter smaller than the diameter of the getter 27.

The first neck portion 36b functions to connect the first and second glass tubes 36a and 36c to each other, to form a passage therebetween, and to confine the getter 27 within the second glass tube 36c. This first neck portion 36b includes the rear end of the first glass tube 36a and the side portion of the second glass tube 36b, each of which has an inner diameter smaller than the diameter of the getter 27.

Meanwhile, the second neck portion 36d is the same as the second neck portion 26d shown in FIG. 3.

Although FIGS. 2 to 5 show only the embodiments in which the exhaust hole, to which the getter tube is attached, is formed in the front side of the LIGHT SOURCE DEVICE, the exhaust hole, to which the getter tube is attached, may be formed in the rear or lateral side of the LIGHT SOURCE DEVICE, instead of the front side of the LIGHT SOURCE DEVICE.

Meanwhile, although the above description illustrates embodiments in which the getter tube is attached to an LIGHT SOURCE DEVICE to be applied to an LCD, it will be apparent to developers having ordinary skill in the art that the getter tube according to the present invention can be applied to a process of manufacturing a Plasma Display Panel (PDP) in the same way without departing from the scope of the present invention.

In the case where the vacuum/exhaust and getter tube, in which a vacuum/exhaust tube and a getter tube are integrated, according to the present invention, is employed, the number of passages in the glass substrate of the LIGHT SOURCE DEVICE, which are used for vacuum/exhaust and mercury injection, is reduced from two to one. Meanwhile, there is a problem in that luminance is reduced around vacuum/exhaust and mercury holes formed in a glass substrate compared to the other regions of the glass substrate. According to the present invention, the number of the holes can be reduced by half, therefore the overall luminance becomes relatively uniform.

Furthermore, as described above, in an existing process of manufacturing an LIGHT SOURCE DEVICE, an existing exhaust tube and an existing getter tube must be respectively separated from holes in a tip-off process, whereas, when the vacuum/exhaust and getter tube according to the present invention is employed, only a single process of removing the vacuum/exhaust and getter tube is necessary. As a result, the complexity of processes can be reduced.

As described above, the vacuum/exhaust and getter tube according to the present invention integrates an existing vacuum/exhaust tube and an existing getter tube into a single tube, thereby simplifying the tip-off process and improving the luminance of the LIGHT SOURCE DEVICE and the uniformity of the luminance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A vacuum/exhaust and getter tube, comprising:
a tube upper and lower ends of which are open; and
a getter which is inserted into the tube.

2. The vacuum/exhaust and getter tube as set forth in claim 1, wherein the tube comprises:
a first tube upper and lower ends of which are open;
a second tube into which the getter is inserted, and upper and lower ends of which are open; and
a first neck portion which is formed between the first and second tubes to be narrower than each of the first and second tubes, and which provides a passage between the first and second tubes.

3. The vacuum/exhaust and getter tube as set forth in claim 2, further comprising a second neck portion which is formed at a lower end of the second tube to be narrower than the second tube, and which provides a passage between the second tube and plasma discharge channels of a light source device.

4. The vacuum/exhaust and getter tube as set forth in claim 3, wherein each of the first and second neck portions has an inner diameter smaller than a diameter of the getter.

5. A vacuum/exhaust and getter tube, comprising:
a tube a part of a side and a lower end of which are open; and
a getter which is inserted into the tube.

6. The vacuum/exhaust and getter tube as set forth in claim 5, wherein the tube comprises:
a first tube front and rear ends of which are open;
a second tube into which the getter is inserted, and a portion of a side and a lower end of which are open; and
a first neck portion which is formed between the first and second tubes to be narrower than each of the first and second tubes, and which provides a passage between the first and second tubes.

7. The vacuum/exhaust and getter tube as set forth in claim 6, further comprising a second neck portion which is formed at a lower end of the second tube to be narrower than the second tube, and which provides a passage between the second tube and plasma discharge channels of an LIGHT SOURCE DEVICE.

8. The vacuum/exhaust and getter tube as set forth in claim 7, wherein each of the first and second neck portions has an inner diameter smaller than a diameter of the getter.

9. The vacuum/exhaust and getter tube as set forth in any one of claims 3 or 6, wherein the second neck portion is attached to an exhaust/mercury injection hole that is located on one of front, side and rear surfaces of the LIGHT SOURCE DEVICE.
